(19) United States
(12) Patent Application Publication
(10) Pub. No.: US 2026/0116661 A1
(43) Pub. Date: Apr. 30, 2026

(54) Multi-motor synchronous travel four-way shuttle

(71) Applicant: Bullseye Intelligent Logistics Equipment (Suzhou) Co.,Ltd., Suzhou (CN)

(72) Inventors: Jian Shen, Suzhou (CN); Libin Kuai, Suzhou (CN); Youcai Shen, Suzhou (CN); Xiangming Wang, Suzhou (CN); Linhua Chen, Suzhou (CN)

(21) Appl. No.: 19/201,751

(22) Filed: May 7, 2025

(30) Foreign Application Priority Data
Oct. 29, 2024 (CN) 202411521613.X

(51) Int. Cl. B65G 1/04

(52) U.S. Cl. CPC B65G 1/0492

(57) ABSTRACT

This invention presents a multi-motor synchronous traveling four-way shuttle, designed for enhanced accuracy and efficiency in movement. It includes a pallet, two X-direction and two Y-direction traveling units, drive assemblies, and a lifting assembly for direction switching. The shuttle utilizes a multi-motor direct-drive structure to increase driving torque and ensure synchronized motor rotation, preventing movement inaccuracies caused by loosening in chain or belt systems. The driving wheels feature an integrated servo motor and reducer, optimizing internal space in small models while boosting power, making it suitable for carrying heavy materials. Additionally, the lifting motor, first reducer, and drive shafts drive two lifting gearboxes to rotate the cam swing arm, adjusting the height between the first and second support plates to switch the shuttle's moving direction. It improves compactness and load-bearing capability while maintaining precise movement control.

### TECHNICAL FIELD

The present invention relates generally to warehousing logistics equipment, and more specifically, to a multi-motor synchronous travel four-way shuttle.

### DESCRIPTION OF THE RELATED ART

A four-way shuttle, also known as a four-way storage vehicle or four-way handling vehicle, is an automated handling device used in warehouses and logistics centers to improve the efficiency and accuracy of material handling. In high-density storage scenarios, shelves or floors are typically tall, and the entry/exit points for goods are usually on the ground floor or first floor. In such cases, a four-way shuttle is needed to transport goods to higher levels via a layer-changing lift, enabling goods to be stored or retrieved from high-level storage locations. The four-way shuttle can move in four directions and is commonly used for storing and retrieving goods. It is characterized by excellent flexibility, a high degree of automation, strong safety features, and high efficiency.

Patent application CN114715573A, published on Jul. 8, 2022, titled “A Single-Motor Four-Way Drive System Applied to Warehouse Four-Way Shuttle,” describes a system that includes an X-direction mechanical mechanism, installed on the warehouse four-way shuttle, allowing it to move along the X direction; a Y-direction mechanical mechanism, installed on the warehouse four-way shuttle, allowing it to move along the Y direction; a hydraulic power mechanism, installed on the warehouse four-way shuttle, which drives both the X-direction and Y-direction mechanical mechanisms while preventing interference between them. This patent application introduces a single-motor four-way drive wheel with a mechanical structure that provides high stability and low risk. Compared to dual-motor systems, it is more energy-efficient and suitable for track-guided four-way shuttle, which require multiple functions and stable working conditions. The mechanical structure also optimizes space utilization, making it advantageous in automated warehouses. Additionally, it features a simple and reliable structure that enhances the efficiency of logistics systems in automated storage environments.

However, while the above-mentioned four-way shuttle includes mechanical mechanisms for movement along the X and Y directions and a hydraulic power mechanism for switching directions, it contains a large number of mechanical components. The presence of numerous components can lead to significant travel distance deviations, making it difficult to precisely control the pickup and delivery of goods. Additionally, the single-motor drive system may struggle with insufficient power when handling heavier loads.

### BRIEF SUMMARY OF THE INVENTION

In light of the aforementioned disadvantages of existing technologies, the present invention provides a multi-motor synchronous travel four-way shuttle.

The multi-motor synchronous travel four-way shuttle comprises: a pallet, which is used for carrying goods; two X-direction travel units and two Y-direction travel units, forming a rectangle and arranged in an alternating manner; each X-direction travel unit includes a first support plate, and each Y-direction travel unit includes a second support plate; each of the first and second support plates has two ends, with one end of a first support plate slidably connected to one end of a second support plate; driving assemblies, each controlled by a controller and including a servo motor with its output end connected to a driving wheel; each end of the first and second support plates is equipped with a driving assembly; the driving wheels on the first support plates rotate synchronously to enable movement in the X direction, while the driving wheels on the second support plates rotate synchronously to enable movement in the Y direction; a lifting assembly, including a mounting plate with a lifting motor installed; an output end of the lifting motor is connected to a first reducer; two lifting gearboxes are symmetrically arranged at two ends of the mounting plate, with the first reducer connected to one of the lifting gearboxes; each lifting gearbox is parallel to a first support plate, and the two lifting gearboxes are connected by a lifting drive shaft; each lifting gearbox is equipped with two cam swing arms, which are driven by the lifting motor to rotate and switch the shuttle's movement direction.

Preferably, in the multi-motor synchronous travel four-way shuttle, each lifting gearbox has two ends, with each end bolted to a second support plate, forming a rectangular arrangement with the two lifting gearboxes and the two second support plates in an alternating manner.

Preferably, in the multi-motor synchronous travel four-way shuttle, each first support plate has two ends, with each end provided with sliding parts; each second support plate has two ends, with each end provided with connecting parts; the connecting parts and sliding parts are slidably connected.

Preferably, in the multi-motor synchronous travel four-way shuttle, the first support plates and second support plates are equipped with multiple anti-collision wheels, and each anti-collision wheel is covered with a rubber layer.

Preferably, in the multi-motor synchronous travel four-way shuttle, each driving assembly includes multiple touch switches, which are arranged on the second support plate to control the driving assembly.

Preferably, in the multi-motor synchronous travel four-way shuttle, each driving wheel includes a second reducer connected to the servo motor; an output end of the second reducer is equipped with a rubber-coated wheel, and another end of the second reducer is equipped with a motor brake to stop the servo motor; the rubber-coated wheel is covered with a protective plate.

Preferably, in the multi-motor synchronous travel four-way shuttle, both the first reducer and the second reducer are planetary gear reducers.

Preferably, in the multi-motor synchronous travel four-way shuttle, each lifting gearbox includes a gearbox housing, inside which multiple gears are installed; two gears are positioned at the two ends of each lifting gearbox, with gear shafts extending outside the gearbox housing; each gear shaft is connected to a cam swing arm, and an outer side of each cam swing arm is equipped with a cam bearing, which is mounted on the gear shaft.

Preferably, in the multi-motor synchronous travel four-way shuttle, each first support plate is symmetrically provided with two sliding grooves, with each sliding groove containing a sliding cam bearing.

In this respect, before explaining at least one embodiment of the invention in detail, it is to be understood that the invention is not limited in its application to the details of construction and to the arrangements of the components set forth in the following description or illustrated in drawings. The invention is capable of other embodiments and of being practiced and carried out in various ways. Also, it is to be understood that the phraseology and terminology employed herein are for the purpose of the description and should not be regarded as limiting.

The advantages of the present disclosure are as follows:

First, the invention features multiple drive components arranged in the same travel direction, with each drive wheel connected to a separate servo motor. This multi-motor direct-drive structure increases the driving torque of the four-way shuttle. By controlling multiple motors to rotate synchronously, it eliminates inaccuracies in movement caused by looseness in chain or belt transmission structures.

Second, the invention integrates the servo motor and reducer into a single mechanism within the drive wheel. This allows for independent installation of the drive wheels while minimizing space usage. It improves the internal space limitations of small-sized models while enhancing power, making it easier for the four-way shuttle to carry heavy loads in a compact design.

Third, the invention includes a lifting motor, a first reducer, and a lifting drive shaft that drives two lifting gearboxes. These gearboxes, in turn, rotate the cam swing arms mounted on them, adjusting the height position between the first support plate and the second support plate. This mechanism enables the four-way shuttle to switch its travel direction smoothly.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the multi-motor synchronous travel four-way shuttle.

FIG. 2 is a front view of the multi-motor synchronous travel four-way shuttle traveling in the X-direction.

FIG. 3 is a side view of the multi-motor synchronous travel four-way shuttle traveling in the Y direction without a load.

FIG. 4 is another side view of the multi-motor synchronous travel four-way shuttle traveling in the Y-direction with a load.

FIG. 5 is a perspective view showing the inside structure of the multi-motor synchronous travel four-way shuttle.

FIG. 6 is a perspective view of the X-direction travel assembly with servo motor, drive wheels, and anti-collision wheel.

FIG. 7 is a perspective view of the Y-direction travel assembly with servo motor, drive wheels, touch switch, and anti-collision wheel.

FIG. 8 is a perspective view of the drive assembly, excluding the touch switch.

FIG. 9 is a perspective view of the lifting assembly (excluding the mounting plate and lifting drive shaft) and the housing.

### DETAILED DESCRIPTION OF THE INVENTION

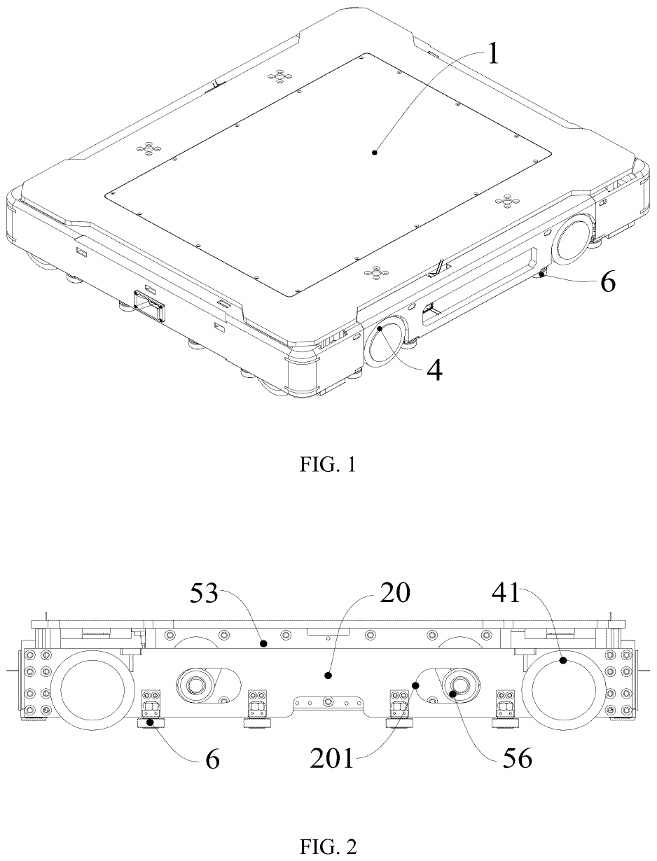

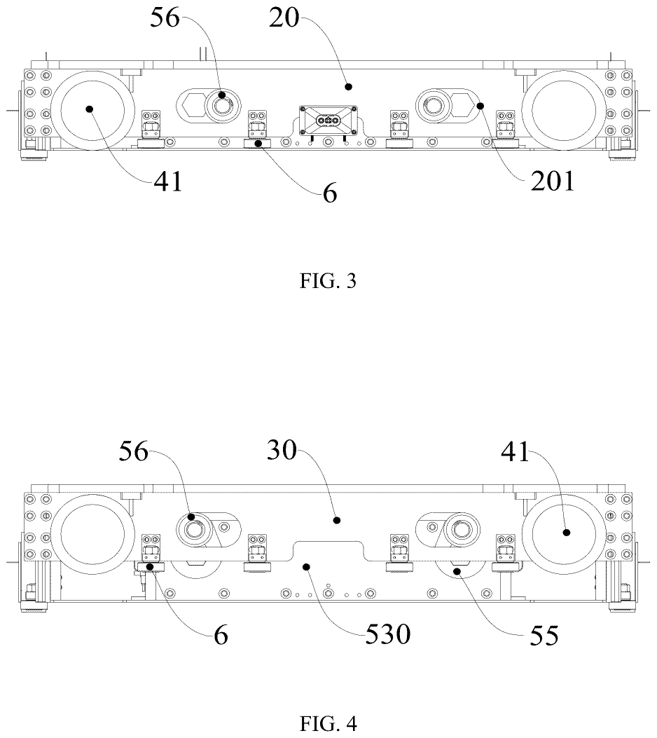

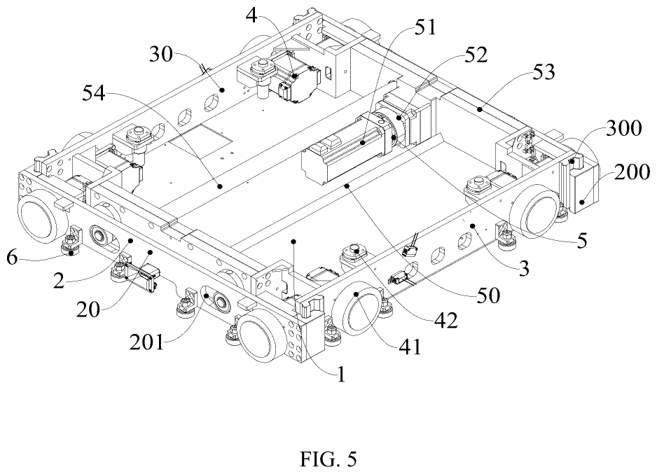

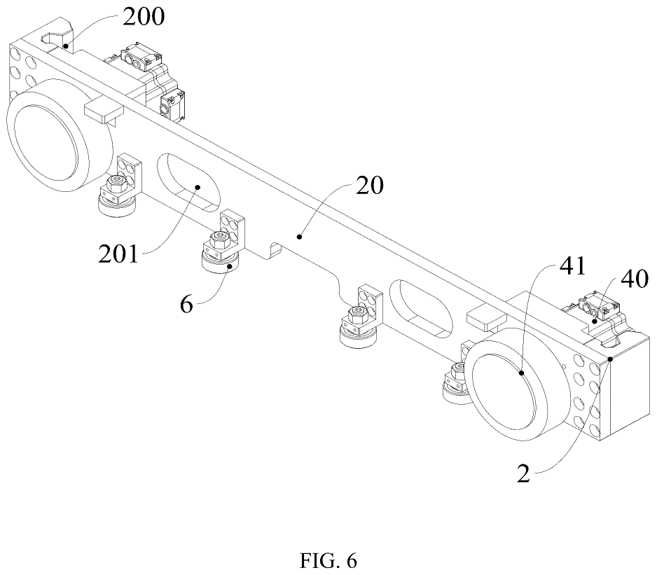

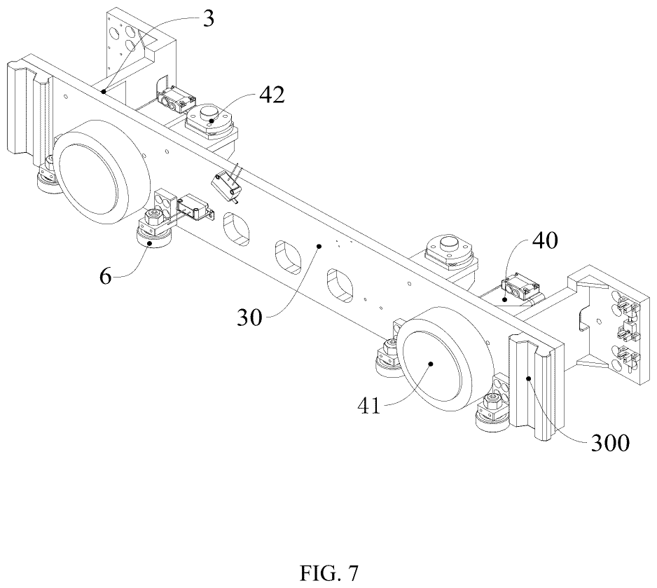

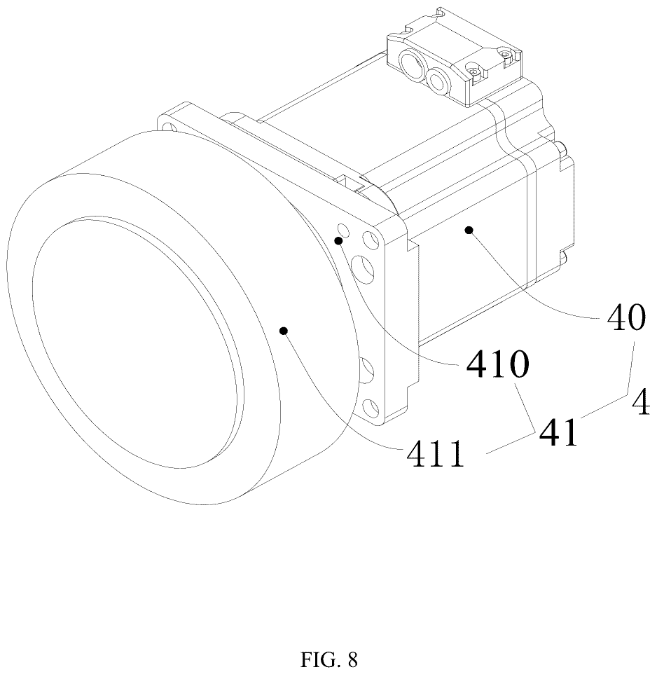

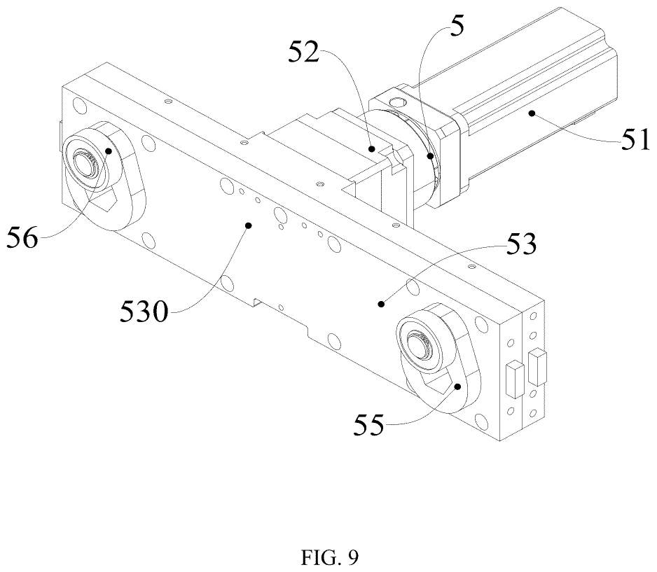

Turning now descriptively to the drawings, in which similar reference characters denote similar elements throughout the several views, FIG. 1 to FIG. 9 illustrate an embodiment of a multi-motor synchronized four-way shuttle, which includes:

A pallet 1, used for carrying goods. Below the pallet 1, there are two sets of X-direction travel unit 2 and two sets of Y-direction travel unit 3. The X-direction travel units 2 and Y-direction travel units 3 form a rectangular arrangement and are spaced apart. Each X-direction travel unit 2 includes a first support plate 20, which is fixedly connected to the lower end of the pallet 1. Each end of the first support plate 20 is equipped with a drive assembly 4. Each Y-direction travel assembly 3 includes a second support plate 30, with a drive assembly 4 installed at each end. The ends of each first support plate 20 are configured to slide along the ends of the second support plates 30.

The drive assembly 4 is controlled by a controller and includes a servo motor 40, which has a drive wheel 41 at its output end. The four drive wheels 41 on the two first support plates 20 can rotate synchronously to move the four-way shuttle in the X direction, while the four drive wheels 41 on the two second support plates 30 can rotate synchronously to move the four-way shuttle in the Y direction.

A lifting assembly 5, which includes a mounting plate 50 on which a lifting motor 51 is installed. The output of the lifting motor 51 is connected to a first reducer 52. Two lifting gearboxes 53 are symmetrically positioned at both ends of the mounting plate 50. The output of the first reducer 52 is connected to one of the lifting gearboxes 53. Each lifting gearbox 53 is parallel to one of the first support plates 20. A lifting drive shaft 54 connects the two lifting gearboxes 53. Each lifting gearbox 53 has two cam swing arms 55 on its outer side. The cam swing arms 55 are driven to rotate by the lifting motor 51, allowing the four-way shuttle to switch its travel direction.

In another embodiment, both ends of the lifting gearbox 53 are connected to a second support plate 30 via bolted connections. The lifting gearbox 53 and the second support plate 30 form a rectangular structure and are spaced apart.

The specific implementation is as follows: both ends of the lifting gearbox 53 are bolted to a second support plate 30, meaning that the second support plate 30 is fixedly connected to the ends of the lifting gearbox 53 via bolts. The two lifting gearboxes 53 and the two second support plates 30 are arranged with spacing between them, forming a rectangular structure. In this way, the two lifting gearboxes 53 and the two second support plates 30 together create the basic frame of the four-way shuttle. Additionally, using bolts allows for the replacement and assembly of second support plates 30 and lifting gearboxes 53 of different sizes. At the same time, the corresponding first support plates 20 can also be replaced to assemble four-way shuttle of different sizes, making them adaptable to various shelf and cargo dimensions.

In another embodiment, both ends of the first support plate 20 are each equipped with a sliding part 200, while both ends of the second support plate 30 are each equipped with a connecting part 300, which is slidably connected to the sliding part 200.

The specific implementation is as follows: each end of the second support plate 30 is equipped with a connecting part 300, and each end of the first support plate 20 is equipped with a sliding part 200. A first support rod is arranged between each connecting part 300 and sliding part 200. Two first support rods are spaced apart from two second support rods, forming a rectangular structure. Thus, when the controller controls the lifting motor 51 to operate, the lifting motor 51 drives the first reducer 52 and the lifting drive shaft 54 to rotate both lifting gearboxes 53 synchronously. This rotation causes the cam swing arms 55, which are installed on the lifting gearboxes 53, to adjust the height position between the first support rods and the second support rods. This height adjustment allows the four-way shuttle to switch its traveling direction based on different height positions of the first support rods and second support rods.

In another embodiment, multiple collision prevention wheels 6 are arranged along the length direction on the outer sides of the first support plate 20 and the second support plate 30. The outer sides of the collision prevention wheel 6 are covered with a rubber layer.

The specific implementation is as follows: the farthest distance from the edge of the collision prevention wheel 6 to the first support plate 20 or the second support plate 30 is greater than the farthest distance from the outer side of the drive wheel 41 to the first support plate 20 or the second support plate 30. In other words, the collision prevention wheels 6 protrude beyond the drive wheels 41. With this design, the collision prevention wheels 6 can protect the four-way shuttle during movement, preventing damage caused by collisions. Additionally, the rubber layer on the outer sides of the collision prevention wheels 6 provides cushioning and shock absorption, preventing direct impact from causing deformation of the first support plate 20 or second support plate 30, which could otherwise hinder their relative sliding movement.

In another embodiment, the drive assembly 4 further includes multiple touch switches 42, which are arranged on the second support plate 30. The drive assembly 4 is also controlled by the touch switches 42.

The specific implementation is as follows: the touch switch 42 is a two-way switch that can send signals to the controller, enabling it to change the operating state of the X-direction travel group 2 and the Y-direction travel group 3.

When the four-way shuttle moves along the X direction, the touch switch 42 comes into contact with the lower end of the tray 1, and its button is pressed. At this moment, the drive assembly 4 of the X-direction travel group 2 is in an ON state, while the drive assembly 4 of the Y-direction travel group 3 is in an OFF state. The controller then activates the drive assembly 4 of the X-direction travel group 2, while the drive assembly 4 of the Y-direction travel group 3 remains inactive. This allows the controller to control the servo motor 40 of the X-direction travel group 2, which drives the drive wheels 41 to rotate, enabling the four-way shuttle to move in the X direction.

When the four-way shuttle switches from X-direction movement to Y-direction movement, the controller activates the lifting motor 51, which in turn drives the first reducer to rotate. The first reducer then drives the gears inside the connected lifting gearbox 53. Simultaneously, the gears inside the lifting gearbox 53 drive the lifting drive shaft to rotate synchronously, transmitting motion to the gears inside the opposite lifting gearbox 53. As a result, both lifting gearboxes 53 synchronously drive the two cam swing arms 55 attached to them. The cam swing arms 55 then move the lifting assembly 5 and the second support rods downward along the first support rods, allowing the drive wheels 41 of the Y-direction travel group 3 to contact the track.

At the same time, the touch switch 42 moves down with the second support plate 30 and disengages from the tray 1, causing its button to rebound. At this point, the Y-direction travel group 3 is in an ON state, while the drive assembly 4 of the X-direction travel group 2 is in an OFF state. The controller then activates the drive assembly 4 of the Y-direction travel group 3, while the drive assembly 4 of the X-direction travel group 2 remains inactive. This allows the controller to control the servo motor 40 of the Y-direction travel group 3, which drives the drive wheels 41 to rotate, enabling the four-way shuttle to move in the Y direction.

In another embodiment, the drive wheel 41 includes a second reducer 410, which is connected to the servo motor 40. The output end of the second reducer 410 is equipped with a rubber-coated wheel 411, while the other end of the second reducer 410 is fitted with a motor brake, which is used to stop the rotation speed of the servo motor 40. Additionally, a cover plate is installed on the outer side of the rubber-coated wheel 411.

The specific implementation is as follows: the servo motor 40 drives the second reducer 410, which in turn rotates the rubber-coated wheel 411 attached to it. This enables the rubber-coated wheel 411 to propel the four-way shuttle along the track.

While the rubber-coated wheel 411 is moving the four-way shuttle, the controller can control the activation, deactivation, and rotational angle of the lifting motor 51. This allows the lifting motor 51 to drive the first reducer, the lifting drive shaft, and the lifting gearbox 53, which in turn rotates the cam swing arms 55 to switch the travel direction of the four-way shuttle.

When the four-way shuttle reaches a designated position, it must be stopped precisely at the specified location. To achieve this, the system is equipped with a motor brake, which stops the servo motor 40 from rotating. This motor brake is an existing technology, so further elaboration is omitted. The motor brake ensures that the servo motor 40 halts at the exact position required.

The rubber-coated wheel 411 provides excellent shock absorption, effectively reducing impact forces, preventing slippage, and protecting the four-way shuttle. Additionally, the cover plate enhances protection and improves the aesthetic appearance of the product.

In another embodiment, both the first reducer 52 and the second reducer 410 are planetary gear reducers.

The specific implementation is as follows: the planetary gear reducer minimizes energy loss during the reduction process, making the system more efficient. Additionally, the distributed structure of the planetary gear reducer allows it to withstand higher torque. Its relatively compact design provides a high transmission ratio even within limited space.

In another embodiment, the lifting gearbox 53 includes a gearbox housing 530, inside which multiple gears are set. Two gears near the end of the gearbox housing 530 serve as gear shafts, and these gear shafts extend outside the gearbox housing 530. Each gear shaft is connected to one of the cam swing arms 55, and the outer side of the cam swing arm 55 is equipped with a cam bearing 56, which is mounted on the gear shaft.

The specific implementation is as follows: when switching the four-way shuttle's travel direction, the controller controls the lifting motor 51 to rotate. This drives the lifting motor 51 through the first reducer and lifting drive shaft 54, causing the gears inside the two lifting gearboxes 53 to rotate synchronously. The gears then drive the gear shafts that mesh with them, causing the gear shafts to rotate. This, in turn, drives the cam swing arms 55 installed on the gear shafts to rotate. Simultaneously, the cam bearing 56 rotates with the cam swing arms 55, enabling the cam swing arms 55 and cam bearing 56 to move the entire lifting assembly 5 and second support plate 30 along the first support plate 20, thereby switching the travel direction of the four-way shuttle.

By controlling the rotation angle of the lifting motor 51, the controller can cyclically switch the four-way shuttle's travel direction between the X and Y directions, allowing the four-way shuttle to adapt to different positions on the shelf.

In another embodiment, two sliding grooves 201 are symmetrically arranged on the first support plate 20, with each sliding groove 201 containing a cam bearing 56 that slides.

The specific implementation is as follows: the sliding groove 201 has a runway shape, meaning it is rectangular in the middle and semi-circular at both ends. The lifting motor 51, through the first reducer 52 and the lifting drive shaft 54, drives the gears inside the two lifting gearboxes 53 to rotate synchronously. This causes the cam swing arms 55 mounted on the outside of the lifting gearboxes 53 to rotate, which in turn drives the cam bearings 56 to rotate synchronously. The rotation of the cam swing arms 55 and cam bearings 56 adjusts the position height between the first support plate 20 and second support plate 30, thereby changing the travel direction of the four-way shuttle.

Specifically, there are three states between the cam swing arm 55, cam bearing 56, and sliding groove 201:

First State: The cam swing arm 55 drives the cam bearing 56 to the lowest point. The two cam bearings 56 on the same first support plate 20 are the farthest apart in the sliding groove 201. In this state, the four-way shuttle moves along the X-direction of the track and is in the X-direction without load and pickup mode.

Second State: Based on the first state, the controller controls the lifting motor 51 to move. This causes the lifting motor 51 through the first reducer and lifting drive shaft 54 to rotate multiple gears synchronously within the lifting gearboxes 53. These gears drive the gear shafts they mesh with to rotate. The rotating gear shafts then drive the cam swing arms 55 to rotate, moving the cam bearings 56 to align with the length direction of the cam swing arms 55. The two cam bearings 56 on the same first support plate 20 are closest together in the sliding groove 201, causing the four-way shuttle to move along the Y-direction of the track in the Y-direction without load mode.

Third State: Based on the second state, the controller continues to control the lifting motor 51 to rotate. This results in the lifting motor 51 rotating multiple gears synchronously in the lifting gearboxes 53, which drives the gear shafts and cam swing arms 55 to rotate. The cam bearing 56 reaches the highest point, and the two cam bearings 56 on the same first support plate 20 are the farthest apart in the sliding groove 201. In this state, the four-way shuttle continues to move along the Y-direction of the track and is in the Y-direction pickup mode. In this state, the controller can continue to control the lifting motor 51 to transition the four-way shuttle from the third state back to the first state.

The cam bearing 56 is designed to reduce friction with the sliding groove 201, allowing the cam bearing 56 to slide smoothly within the sliding groove 201.

According to the size of the shelf and the goods, different sizes of the second support plate 30 and lifting gearbox 53 can be assembled and replaced using bolts. A second support plate 30 is installed at both ends of the lifting gearbox 53 by bolts, and the two lifting gearboxes 53 are arranged in intervals between the second support plates 30, forming a rectangular shape. Additionally, the first support plate 20 is replaced with one of the corresponding sizes to assemble four-way shuttles of different sizes.

Furthermore, through the connecting part 300 and sliding part 200, two first support rods and two second support rods are arranged at intervals, forming a rectangle between the first and second support rods. This allows the controller to control the movement of the lifting motor 51, which, through the first reducer 52 and lifting drive shaft 54, drives the two lifting gearboxes 53 to rotate synchronously. As a result, the cam swing arm 55 mounted on the lifting gearbox 53 adjusts the height between the first support rod and second support rod, allowing the four-way shuttle to change its travel direction at different height positions.

When the four-way shuttle moves, the servo motor 40 drives the second reducer to rotate, which in turn drives the rubber-coated wheel 411 mounted on it to rotate. This causes the rubber-coated wheel 411 to drive the four-way shuttle along the track. Meanwhile, the controller can control the lifting motor 51's start/stop and rotation angle. The lifting motor 51, through the first reducer, lifting gear shaft, and lifting gearbox 53, drives the cam swing arm 55 to rotate, which switches the direction of movement of the four-way shuttle. Once the four-way shuttle reaches a designated position, it needs to stop at that position. To achieve this, the motor brake is applied to stop the speed of the servo motor 40, which is a well-known technology. The motor brake ensures that the servo motor 40's speed is halted at the designated position.

The rubber-coated wheel 411 has good shock-absorbing properties, which can effectively absorb impacts, prevent sliding, and protect the four-way shuttle. The collision protection wheel 6 protects the edges of the four-way shuttle, preventing damage caused by collisions during movement. The rubber layer on the outer side of the collision protection wheel 6 provides cushioning and shock absorption during collisions, preventing direct impact that could cause deformation of the first support plate 20 or second support plate 30, making it difficult for them to slide relative to each other.

The movement of the four-way shuttle occurs in two directions: the X-direction and the Y-direction:

When the four-way shuttle moves along the X-direction, the touch switch 42 contacts the lower side of the pallet 1, and the button of the touch switch 42 is pressed. At this point, the X-direction walking group 2's drive assembly 4 is in the on state, while the Y-direction walking group 3's drive assembly 4 is in the off state. The controller can control the X-direction walking group 2's drive assembly 4 to move, while the Y-direction walking group 3's drive assembly 4 does not work. This allows the servo motor 40 of the X-direction walking group 2 to drive the drive wheel 41 to rotate, moving the four-way shuttle in the X-direction.

When the four-way shuttle switches from moving in the X-direction to the Y-direction, the controller controls the lifting motor 51 to rotate, causing it, through the first reducer and lifting drive shaft 54, to drive the gears in the two lifting gearboxes 53 to rotate synchronously. These gears drive the gear shafts, which in turn rotate the cam swing arm 55. The cam swing arm 55 and cam bearing 56 drive the entire lifting assembly 5 and second support plate 30 to slide downward along the first support plate 20, making the Y-direction walking group 3's drive wheel 41 contact the track. Simultaneously, the touch switch 42 moves downward with the second support plate 30 and separates from the pallet 1, causing the button of the touch switch 42 to rebound. At this point, the Y-direction walking group 3 is in the on state, while the X-direction walking group 2's drive assembly 4 is in the off state. The controller then controls the Y-direction walking group 3's drive assembly 4 to move, while the X-direction walking group 2's drive assembly 4 does not work. This allows the servo motor 40 of the Y-direction walking group 3 to drive the drive wheel 41 to rotate, moving the four-way shuttle in the Y-direction. Additionally, the controller can control the rotation angle of the lifting motor 51, allowing the cam swing arm 55 and cam bearing 56 to alternate the travel direction of the four-way shuttle between the X-direction and Y-direction, adapting the four-way shuttle to various positions on the shelf.

The specific states between the cam swing arm 55, cam bearing 56, and sliding groove 201 are as follows:

First State: The cam swing arm 55 drives the cam bearing 56 to the lowest point. The two cam bearings 56 on the same first support plate 20 are the farthest apart in the sliding groove 201, causing the four-way shuttle to move along the X-direction of the track. The four-way shuttle is in the X-direction without load and pickup mode.

Second State: Based on the first state, the controller controls the lifting motor 51 to move, causing it to rotate the gears synchronously. This drives the cam swing arm 55 to rotate, positioning the cam bearings 56 along the length direction of the cam swing arm 55. The two cam bearings 56 on the same first support plate 20 are the closest in the sliding groove 201, and the four-way shuttle moves along the Y-direction of the track. The four-way shuttle is in the Y-direction without load mode.

Third State: Based on the second state, the controller continues to control the lifting motor 51 to rotate, causing it to drive the cam swing arm 55 and cam bearings 56 to move the four-way shuttle along the Y-direction of the track. The four-way shuttle is in the Y-direction pickup mode. In this state, the controller can control the lifting motor 51 to return the system to the first state.

The cam bearing 56 is designed to reduce friction with the sliding groove 201, allowing it to slide smoothly within the groove.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A multi-motor synchronous travel four-way shuttle, comprising:
a pallet, which is used for carrying goods;
two X-direction travel units and two Y-direction travel units, forming a rectangle and arranged in an alternating manner; each X-direction travel unit includes a first support plate, and each Y-direction travel unit includes a second support plate; each of the first and second support plates has two ends, with one end of a first support plate slidably connected to one end of a second support plate;
driving assemblies, each controlled by a controller and including a servo motor with its output end connected to a driving wheel; each end of the first and second support plates is equipped with a driving assembly; the driving wheels on the first support plates rotate synchronously to enable movement in the X direction, while the driving wheels on the second support plates rotate synchronously to enable movement in the Y direction;
a lifting assembly, including a mounting plate with a lifting motor installed; an output end of the lifting motor is connected to a first reducer; two lifting gearboxes are symmetrically arranged at two ends of the mounting plate, with the first reducer connected to one of the lifting gearboxes; each lifting gearbox is parallel to a first support plate, and the two lifting gearboxes are connected by a lifting drive shaft; each lifting gearbox is equipped with two cam swing arms, which are driven by the lifting motor to rotate and switch the shuttle's movement direction.

2. The multi-motor synchronous travel four-way shuttle in claim 1, further characterized in that each lifting gearbox has two ends, with each end bolted to a second support plate, forming a rectangular arrangement with the two lifting gearboxes and the two second support plates in an alternating manner.

3. The multi-motor synchronous travel four-way shuttle in claim 1, further characterized in that each first support plate has two ends, with each end provided with sliding parts; each second support plate has two ends, with each end provided with connecting parts; the connecting parts and sliding parts are slidably connected.

4. The multi-motor synchronous travel four-way shuttle in claim 1, further characterized in that the first support plates and second support plates are equipped with multiple anti-collision wheels, and each anti-collision wheel is covered with a rubber layer.

5. The multi-motor synchronous travel four-way shuttle in claim 1, further characterized in that each driving assembly includes multiple touch switches, which are arranged on the second support plate to control the driving assembly.

6. The multi-motor synchronous travel four-way shuttle in claim 1, further characterized in that each driving wheel includes a second reducer connected to the servo motor; an output end of the second reducer is equipped with a rubber-coated wheel, and another end of the second reducer is equipped with a motor brake to stop the servo motor; the rubber-coated wheel is covered with a protective plate.

7. The multi-motor synchronous travel four-way shuttle in claim 6, further characterized in that both the first reducer and the second reducer are planetary gear reducers.

8. The multi-motor synchronous travel four-way shuttle in claim 1, further characterized in that each lifting gearbox includes a gearbox housing, inside which multiple gears are installed; two gears are positioned at the two ends of each lifting gearbox, with gear shafts extending outside the gearbox housing; each gear shaft is connected to a cam swing arm, and an outer side of each cam swing arm is equipped with a cam bearing, which is mounted on the gear shaft.

9. The multi-motor synchronous travel four-way shuttle in claim 8, further characterized in that each first support plate is symmetrically provided with two sliding grooves, with each sliding groove containing a sliding cam bearing.
